(19) United States
(12) Patent Application Publication
(10) Pub. No.: US 2024/0397431 A1
(43) Pub. Date: Nov. 28, 2024

(54) METHOD FOR PERFORMING TRANSMISSION POWER CONTROL OF WIRELESS TRANSCEIVER DEVICE IN WIRELESS COMMUNICATIONS SYSTEM WITH AID OF CHANNEL MODEL DETECTION FOR SELECTIVELY PERFORMING TRANSMISSION POWER BOOST, AND ASSOCIATED APPARATUS

(71) Applicant: MEDIATEK INC., Hsin-Chu (TW)

(72) Inventors: I-Yin Yu, Hsinchu City (TW); Kuan-Chih Kuo, Hsinchu City (TW); Ching-Yu Kuo, Hsinchu City (TW); Hao-Chih Yu, Hsinchu City (TW); Wei-I Chiang, Hsinchu City (TW)

(73) Assignee: MEDIATEK INC., Hsin-Chu (TW)

(21) Appl. No.: 18/673,303

(22) Filed: May 23, 2024

Related U.S. Application Data
(60) Provisional application No. 63/503,967, filed on May 24, 2023.

(51) Int. Cl. H04W 52/14; H04L 1/00; H04W 52/36

(52) U.S. Cl. CPC H04W 52/143; H04L 1/0003; H04W 52/367

(57) ABSTRACT

A method for performing transmission power control of a wireless transceiver device in wireless communications system and associated apparatus are provided. The method may include: obtaining at least one indicator regarding a current channel, for channel detection of the current channel; detecting the current channel based on the at least one indicator to generate at least one channel detection result, wherein when one of the at least one channel detection result indicates a current channel model of the current channel, the current channel model is one of multiple predetermined channel models; and determining at least one transmission power value according to the at least one channel detection result, for performing packet transmission with the at least one transmission power value.

### CROSS REFERENCE TO RELATED APPLICATIONS

This application claims the benefit of U.S. Provisional Application No. 63/503,967, filed on May 24, 2023. The content of the application is incorporated herein by reference.

### BACKGROUND

The present invention is related to communications control, and more particularly, to a method for performing transmission power control of a wireless transceiver device in a wireless communications system, and associated apparatus such as the wireless transceiver device.

According to the related art, the transmission power of a wireless communications device in a wireless communications system is typically decided based on one or more factors among the error vector magnitude (EVM), the transmit spectral mask (or “MASK”), the regulatory factor, etc. with proper margins, and is typically fixed for all channel models (or “scenarios”). For example, the wireless communications device of the related art may set a transmission power value simply according to the Wi-Fi specifications, where the transmission power value is fixed for all channel models. Although the transmission power value may be suitable for a certain channel model, the transmission power value may be unsuitable for some other channel models, and more particularly, may be insufficient for the other channel models. As a result, the unsuitable transmission power value such as the insufficient transmission power value may lead to packet re-transmission due to insufficient reception signal power at the packet reception side. As the transmission EVM requirement is scenario dependent, the wireless communications device of the related art may not operate properly, causing the overall performance to be degraded. Thus, a novel method and associated architecture are needed for solving the problems without introducing any side effect or in a way that is less likely to introduce a side effect.

### SUMMARY

It is an objective of the present invention to provide a method for performing transmission power control of a wireless transceiver device in a wireless communications system, and associated apparatus such as the wireless transceiver device (e.g., a multifunctional mobile phone), in order to solve the above-mentioned problems.

At least one embodiment of the present invention provides a method for performing transmission power control of a wireless transceiver device in a wireless communications system. The method may comprise: obtaining at least one indicator regarding a current channel, for channel detection of the current channel; detecting the current channel based on the at least one indicator to generate at least one channel detection result, wherein when one of the at least one channel detection result indicates a current channel model of the current channel, the current channel model is one of multiple predetermined channel models; and determining at least one transmission power value according to the at least one channel detection result, for performing packet transmission with the at least one transmission power value.

At least one embodiment of the present invention provides a wireless transceiver device for performing transmission power control of the wireless transceiver device in a wireless communications system, where the wireless transceiver device may be one of multiple devices within the wireless communications system. The wireless transceiver device may comprise a processing circuit that is arranged to control operations of the wireless transceiver device. The wireless transceiver device may further comprise at least one communications control circuit that is coupled to the processing circuit and arranged to perform communications control, where the aforementioned at least one communications control circuit is arranged to perform wireless communications operations with another device among the multiple devices within the wireless communications system for the wireless transceiver device. For example, the at least one communications control circuit is arranged to obtain at least one indicator regarding a current channel, for channel detection of the current channel; the at least one communications control circuit is arranged to detect the current channel based on the at least one indicator to generate at least one channel detection result, wherein when one of the at least one channel detection result indicates a current channel model of the current channel, the current channel model is one of multiple predetermined channel models; and the at least one communications control circuit is arranged to determine at least one transmission power value according to the at least one channel detection result, for performing packet transmission with the at least one transmission power value.

It is an advantage of the present invention that, through proper design, the present invention method, as well as the associated apparatus such as the wireless transceiver device (e.g., the multifunctional mobile phone), can adaptively perform scenario-based transmission power control, and more particularly, detect the current channel with the aid of some indicators (e.g., hardware (HW) and/or software (SW) indicators), and adjust the transmission power per modulation and coding scheme (MCS) rate based on the detected channel, in order to selectively boost the resultant transmission power of the wireless transceiver device to prevent the related art problems such as insufficient transmission power, packet re-transmission, etc., and therefore improve the overall performance. Additionally, the present invention method and apparatus can solve the related art problems without introducing any side effect or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a wireless communications system according to an embodiment of the present invention.

FIG. 2 illustrates, in the lower half part thereof, a scenario-based transmission power control scheme of a method for performing transmission power control of a wireless transceiver device in a wireless communications system according to an embodiment of the present invention, where a non-scenario-based transmission power control scheme involved with straightforward setting may be illustrated in the upper half part of FIG. 2 for better comprehension.

FIG. 3 illustrates a hybrid transmission power control scheme of the method according to an embodiment of the present invention.

FIG. 4 illustrates a working flow of the method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

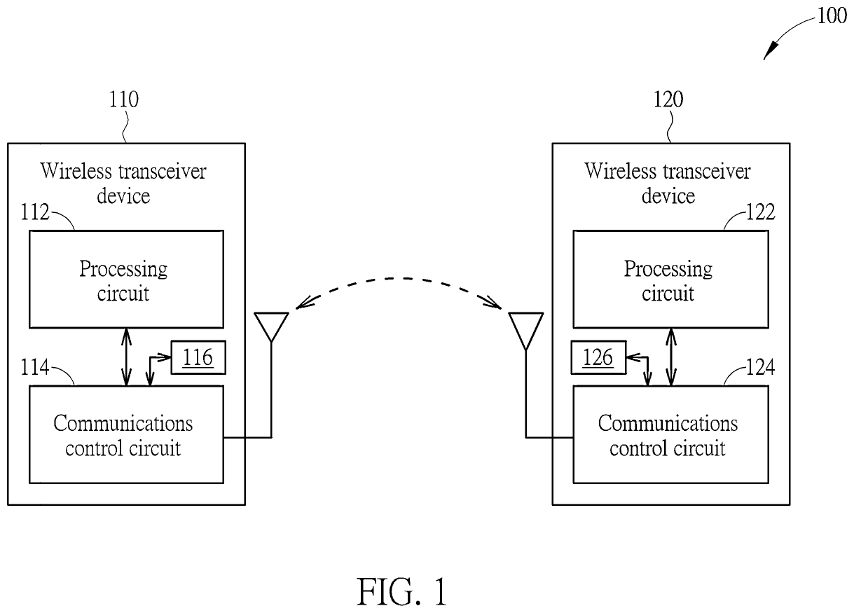

FIG. 1 is a diagram of a wireless communications system 100 according to an embodiment of the present invention. For better comprehension, the wireless communications system 100, as well as any wireless transceiver device #n among multiple wireless transceiver devices #1, . . . and #N therein, may be compatible or backward-compatible to one or more versions of the Institute of Electrical and Electronics Engineers (IEEE) 802.11 standards, but the present invention is not limited thereto. Regarding the multiple wireless transceiver devices #1, . . . and #N within the wireless communications system 100, a wireless transceiver device 110 may represent the wireless transceiver device #1, a wireless transceiver device 120 may represent the wireless transceiver device #2, and the rest may be deduced by analogy. For example, the wireless transceiver device #1 such as the wireless transceiver device 110 may be implemented as an access point (AP) device, and another wireless transceiver device among multiple wireless transceiver devices #1, . . . and #N, such as the wireless transceiver device 120, may be implemented as a station (STA) device, but the present invention is not limited thereto. For another example, both of the wireless transceiver devices #1 and #2 such as the wireless transceiver devices 110 and 120 may be implemented as AP devices. For yet another example, both of the wireless transceiver devices #1 and #2 such as the wireless transceiver devices 110 and 120 may be implemented as STA devices.

As shown in FIG. 1, the wireless transceiver device 110 may comprise a processing circuit 112, at least one communications control circuit (e.g., one or more communications control circuits), which may be collectively referred to as the communications control circuit 114, at least one antenna (e.g., one or more antennas) of the communications control circuit 114, and a storage device 116, and the wireless transceiver device 120 may comprise a processing circuit 122, at least one communications control circuit (e.g., one or more communications control circuits), which may be collectively referred to as the communications control circuit 124, at least one antenna (e.g., one or more antennas) of the communications control circuit 124, and a storage device 126.

In the architecture shown in FIG. 1, the processing circuit 112 can be arranged to control operations of the wireless transceiver device 110, and the communications control circuit 114 can be arranged to perform communications control, and more particularly, perform wireless communications operations with the network (or another device therein such as the wireless transceiver device 120) for the wireless transceiver device 110. For example, the storage device 116 can be arranged to store information, and can be coupled to the communications control circuit 114 to allow the communications control circuit 114 to access (e.g., read or write) the storage device 116, but the present invention is not limited thereto. The storage device 116 can be coupled to the processing circuit 112 for being accessed by the processing circuit 112 and storing information under control of the processing circuit 112. In addition, the processing circuit 122 can be arranged to control operations of the wireless transceiver device 120, and the communications control circuit 124 can be arranged to perform communications control, and more particularly, perform wireless communications operations with the network (or another device therein such as the wireless transceiver device 110) for the wireless transceiver device 120. For example, the storage device 126 can be arranged to store information, and can be coupled to the communications control circuit 124 to allow the communications control circuit 124 to access (e.g., read or write) the storage device 126, but the present invention is not limited thereto. The storage device 126 can be coupled to the processing circuit 122 for being accessed by the processing circuit 122 and storing information under control of the processing circuit 112.

According to some embodiments, the processing circuits 112 and 122 can be implemented by way of at least one processor/microprocessor, at least one random access memory (RAM), at least one bus, etc., the communications control circuits 114 and 124 can be implemented by way of at least one wireless network control circuit, and the storage devices 116 and 126 can be implemented by way of at least one non-volatile memory such as at least one electrically erasable programmable read-only memory (EEPROM), at least one Flash memory, etc., but the present invention is not limited thereto. Examples of the wireless transceiver devices 110 and 120 may include, but are not limited to: a Wi-Fi router, a multifunctional mobile phone, a laptop computer, an all-in-one computer and a wearable device.

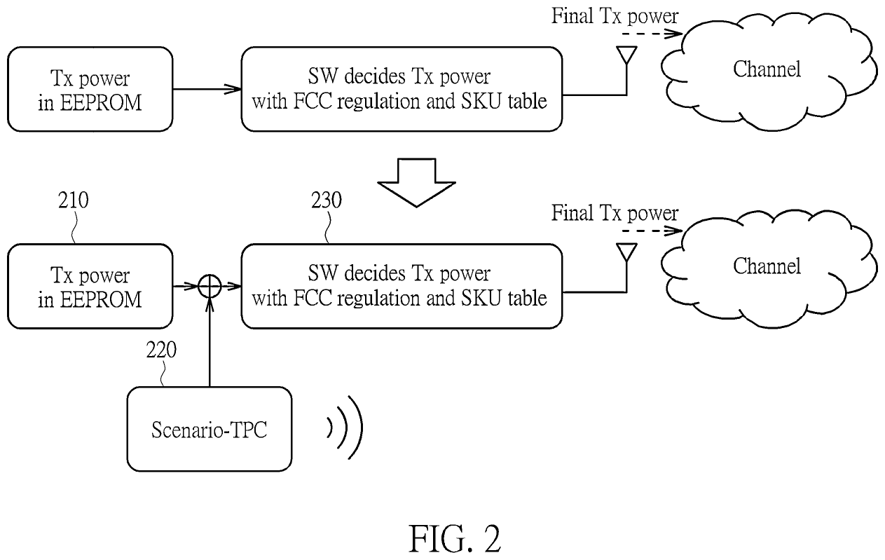

FIG. 2 illustrates, in the lower half part thereof, a scenario-based transmission power control scheme of a method for performing transmission power control of a wireless transceiver device (e.g., the wireless transceiver device #n such as one of the wireless transceiver devices 110 and 120) in a wireless communications system (e.g., the wireless communications system 100) according to an embodiment of the present invention, where a non-scenario-based transmission power control scheme involved with straightforward setting may be illustrated in the upper half part of FIG. 2 for better comprehension. Taking the wireless transceiver device 110 as an example of the wireless transceiver device #n, the associated operations of the wireless transceiver device 110 operating according to the method may comprise:
(1) the wireless transceiver device 110 may utilize the aforementioned at least one communications control circuit therein such as the communications control circuit 114 to obtain at least one indicator (e.g., one or more indicators) regarding a current channel, for performing channel detection of the current channel;
(2) the wireless transceiver device 110 may utilize the communications control circuit 114 to detect the current channel based on the aforementioned at least one indicator to generate at least one channel detection result (e.g., one or more channel detection results), where when one of the aforementioned at least one channel detection result indicates a current channel model of the current channel, the current channel model may be one of multiple predetermined channel models; and
(3) the wireless transceiver device 110 may utilize the communications control circuit 114 to determine at least one transmission power value Tx_power (e.g., one or more transmission power values {Tx_power}) according to the aforementioned at least one channel detection result, for performing packet transmission with the aforementioned at least one transmission power value Tx_power, in order to perform transmission power boost in at least one predetermined channel model among the multiple predetermined channel models without performing the transmission power boost in another predetermined channel model among the multiple predetermined channel models;
where the multiple predetermined channel models may comprise the conductive channel model such as the Butler model, the conditional number, stream delta signal-to-noise ratio (SNR) model such as the big Conditional Number (CN) model, and the delay spread channel models such as the TGN-BL and TGN-ENL models, but the present invention is not limited thereto. As the term “scenario” may represent “channel model” according to some viewpoints, the multiple predetermined channel models may also be referred to as multiple predetermined scenarios. According to some embodiments, the multiple predetermined channel models, the channel model count of the multiple predetermined channel models, the multiple predetermined scenarios, and/or the scenario count of the multiple predetermined scenarios may vary.

More particularly, the aforementioned at least one indicator may comprise a first indicator and a second indicator, and the aforementioned at least one channel detection result may comprise a first channel detection result and a second channel detection result. During utilizing the communications control circuit 114 to detect the current channel based on the aforementioned at least one indicator to generate the aforementioned at least one channel detection result, the wireless transceiver device 110 may utilize the communications control circuit 114 to detect the current channel based on the first indicator to generate the first channel detection result, and to detect the current channel based on the second indicator to generate the second channel detection result. For example, the first channel detection result may indicate that the current channel model of the current channel is a first predetermined channel model among the multiple predetermined channel models, and the second channel detection result may indicate that the current channel model of the current channel is a second predetermined channel model among the multiple predetermined channel models. In addition, the aforementioned at least one transmission power value Tx_power may comprise multiple transmission power values {Tx_power} such as the transmission power values {Tx_power(i)|i=1, 2, . . . }, for performing the packet transmission of multiple packets {Packet(i)|i=1, 2, . . . } (e.g., physical layer (PHY) protocol data units (PPDUs)) with the transmission power values {Tx_power(i)|i=1, 2, . . . }, respectively, where “i” may represent a positive integer, but the present invention is not limited thereto. For example, during utilizing the communications control circuit 114 to determine the aforementioned at least one transmission power value Tx_power according to the aforementioned at least one channel detection result for performing the packet transmission with the aforementioned at least one transmission power value Tx_power, the wireless transceiver device 110 may utilize the communications control circuit 114 to determine a first transmission power value Tx_power(i1) among the multiple transmission power values {Tx_power} according to the first channel detection result, for performing the packet transmission of at least one first packet Packet(i) (e.g., one or more first packets {Packet(i)}) with the first transmission power value Tx_power(i1), and to determine a second transmission power value Tx_power(i2) among the multiple transmission power values {Tx_power} according to the second channel detection result, for performing the packet transmission of at least one second packet Packet(i) (e.g., one or more second packets {Packet(i)}) with the second transmission power value Tx_power(i2), where “i1” and “i2” may represent different integers, and the first transmission power value Tx_power(i1) and the second transmission power value Tx_power(i2) may be different from each other. For example, the aforementioned at least one first packet Packet(i) may comprise a packet Packet(i1) or a set of packets {Packet(i)|i=i1, . . . , (i1+Δi1)}, and the aforementioned at least one second packet Packet(i) may comprise a packet Packet(i1) or a set of packets {Packet(i)|i=i2, . . . , (12+Δi2)}, where “Δi1” and “Δi2” may represent different integers.

For better comprehension, assume that one or more functions of the wireless transceiver device 110 may be temporarily disabled to allow the wireless transceiver device 110 (or the communications control circuit 114 therein) to operate according to the non-scenario-based transmission power control scheme shown in the upper half part of FIG. 2, and the communications control circuit 114 may comprise a first program module such as a first SW module running thereon for controlling the operations of the communications control circuit 114, where the storage device 116 may be implemented by way of EEPROM, but the present invention is not limited thereto. Based on the non-scenario-based transmission power control scheme, the communications control circuit 114 may read a first pre-set transmission (Tx) power value from the EEPROM (labeled “Tx_power in EEPROM” for brevity), and the first SW module running on the communications control circuit 114 may decide a first Tx_power value with the FCC regulations and a stock keeping unit (SKU) table storing the associated SKU information of the wireless transceiver device 110 (labeled “SW decides Tx_power with FCC regulation and SKU table” for brevity), for example, by applying a set of predetermined limitations of the FCC regulations and the SKU table to the first pre-set Tx_power value Tx_power_pre_1 to convert the first pre-set Tx_power value Tx_power_pre_1 into the first Tx_power value to be a first final Tx power for performing packet transmission on a channel (labeled “Final Tx_power” for brevity). Assuming that the one or more factors among the EVM, the MASK, the regulatory factor, etc. may have been determined, the first pre-set Tx_power value Tx_power_pre_1 and the first final Tx power will be fixed for all channel models (or all scenarios) of all channels. In a situation where the first final Tx_power is fixed for all channel models (or all scenarios), although the first final Tx power may be suitable for a certain channel model, the first final Tx_power may be unsuitable for some other channel models, and more particularly, may be insufficient for the other channel models. As a result, the related art problems such as insufficient transmission power, packet re-transmission, etc. may occur, causing the overall performance to be degraded.

As shown in the lower half part of FIG. 2, the wireless transceiver device 110 (or the communications control circuit 114 therein) may operate according to the scenario-based transmission power control scheme to achieve a better overall performance, and the communications control circuit 114 may comprise at least one program module (e.g. one or more program modules) such as a second SW module running thereon for controlling the operations of the communications control circuit 114, where the storage device 116 may be implemented by way of EEPROM, but the present invention is not limited thereto. Based on the scenario-based transmission power control scheme, the communications control circuit 114 may perform a preliminary Tx_power determination operation 210 to read the second pre-set Tx_power value Tx_power_pre_2 from the EEPROM (labeled “Tx_power in EEPROM” for brevity). In addition, the communications control circuit 114 may perform a scenario-Tx_power control (TPC) operation 220 (labeled “Scenario-TPC” for brevity) to determine a boost power value Boost_power according to the current channel model of the current channel, and add the second pre-set Tx power value Tx_power_pre_2 and the boost power value Boost power to generate the summation (Tx_power_pre_2+Boost_power) of the second pre-set Tx_power value Tx_power_pre_2 and the boost power value Boost_power to be a boost Tx_power value Tx_power boost. Additionally, the second SW module running on the communications control circuit 114 may perform a resultant Tx power determination operation 230 according to the boost Tx_power value Tx_power_boost to decide a second Tx_power value with the FCC regulations and the SKU table storing the associated SKU information of the wireless transceiver device 110 (labeled “SW decides Tx_power with FCC regulation and SKU table” for brevity), for example, by applying the set of predetermined limitations of the FCC regulations and the SKU table to the boost Tx_power value Tx_power_boost to convert the boost Tx_power value Tx_power_boost into the second Tx_power value to be a second final Tx_power for performing packet transmission on the current channel (labeled “Final Tx_power” for brevity).

The communications control circuit 114 may be arranged to determine the aforementioned at least one transmission power value Tx_power per MCS rate according to the aforementioned at least one channel detection result, for performing the packet transmission with the aforementioned at least one transmission power value Tx_power. When there is a need, the communications control circuit 114 may transmit multiple sets of packets {Packet} among the multiple packets {Packet(i)|i=1, 2, . . . } at different MCS rates, respectively. According to the channel variation indicated by the aforementioned at least one channel detection result, the communications control circuit 114 may dynamically adjust the transmission power (e.g., the Tx power values {Tx_power} such as the boost Tx_power values {Tx_power_boost}) of the packet transmission, for example, per MCS rate. Regarding the dynamic Tx_power depending on different channels (or different channel models thereof), the wireless transceiver device 114 can adaptively perform scenario-based transmission power control, and more particularly, detect the current channel with the aid of the indicators (e.g., HW and/or SW indicators), and adjust the transmission power per MCS rate based on the detected channel, in order to selectively boost the resultant transmission power of the wireless transceiver device 110, and therefore improve the overall performance.

TABLE 1

| | Channel Model | Target Tx Power | Final Tx power |
|---|---|---|---|
| Non-scenario-based | Ch_Model(1) | Tx_power_pre_1 | Tx_power_pre_1′ |
| transmission power | Ch_Model(2) | | |
| control scheme | . . . | | |
| Scenario-based | Ch_Model(1) | Tx_power_boost(1) | Tx_power_boost′(1) |
| transmission power | Ch_Model(2) | Tx_power_boost(2) | Tx_power_boost′(2) |
| control scheme | . . . | . . . | . . . |

Table 1 illustrates an example of comparison between the scenario-based transmission power control scheme and the non-scenario-based transmission power control scheme, where the multiple predetermined channel models may be written as the multiple predetermined channel models {Ch_Model(m)|m=1, 2, . . . } such as the M predetermined channel models Ch_Model(1), Ch_Model(2), . . . and Ch_Model(M), and the symbol “ . . . ” shown in Table 1 may indicate that some table contents may be omitted, but the present invention is not limited thereto. Based on the non-scenario-based transmission power control scheme, the target Tx_power before applying the set of limitations of the FCC regulations and the SKU table may be equal to the first pre-set Tx power value Tx_power pre_1, and the final Tx_power after applying the set of limitations of the FCC regulations and the SKU table may be written as the Tx_power value Tx_power_pre_1′. The first pre-set Tx_power value Tx_power pre_1 may be decided in advance, for example, in a preliminary phase (e.g., a pilot run phase or a mass production phase) before a user phase of the wireless transceiver device 110. As the target Tx_power such as the first pre-set Tx_power value Tx_power_pre_1 is fixed for all channel models {Ch_Model(m)} (or all scenarios), the final Tx power such as the Tx_power value Tx_power pre_1′ is also fixed for all channel models {Ch_Model(m)} (or all scenarios).

Based on the scenario-based transmission power control scheme, the communications control circuit 114 may perform the scenario-TPC operation 220 to determine the boost power value Boost_power(m) according to the current channel model of the current channel, and add the second pre-set Tx_power value Tx_power_pre_2 and the boost power value Boost_power(m) to generate the summation (Tx_power_pre_2+Boost_power(m)) of the second pre-set Tx_power value Tx_power pre_2 and the boost power value Boost_power(m) to be the boost Tx_power value Tx_power_boost(m), where the second pre-set Tx_power value Tx_power pre_2 may be decided in advance, for example, in the preliminary phase (e.g., the pilot run phase or the mass production phase) of the wireless transceiver device 110. As boosting the resultant transmission power of the wireless transceiver device 110 may be selectively performed, the communications control circuit 114 may dynamically determine the boost power value Boost_power(m) as a value greater than or equal to zero, but the present invention is not limited thereto. In addition, the target Tx_power before applying the set of limitations of the FCC regulations and the SKU table may be equal to the boost Tx_power value Tx_power_boost(m), and the final Tx_power after applying the set of limitations of the FCC regulations and the SKU table may be written as the Tx_power value Tx_power_boost′(m). For example, when m=1, Tx_power_boost (1)=Tx_power_pre_2+Boost_power(1); when m=2, Tx_power_boost (2)=Tx_power_pre_2+Boost_power(2); and the rest may be deduced by analogy, for example, when m=M, Tx_power_boost (M)=Tx_power_pre_2+Boost_power(M). As the target Tx_power such as the boost Tx_power values {Tx_power boost(m)} can be adaptively determined according to the channel models {Ch_Model(m)} (or the scenarios), the final Tx_power such as the Tx_power values {Tx_power_boost′ (m)} can also be adaptively determined according to the channel models {Ch_Model(m)} (or the scenarios).

With the scenario detection, the communications control circuit 114 can dynamically adjust the Tx power to get better rate vs. range (RvR) extension, and more particularly, detect the current channel with some indicators and adjust the Tx power per MCS rate based on the detected channel. For example, in a less EVM-demanding scenario like the Butler model, the wireless transceiver device 110 (e.g., the AP device) can transmit higher power to get a better throughput (T-put). On the other hand, the wireless transceiver device 110 (e.g., the AP device) can apply lower Tx power in the big CN model, which is a high EVM-demanding scenario. Therefore, the wireless transceiver device 110 can improve the RvR extension by Tx power boost in some less EVM-required channel models, in order to enhance the wireless throughput with respect to the attenuation (or the path loss in signal level).

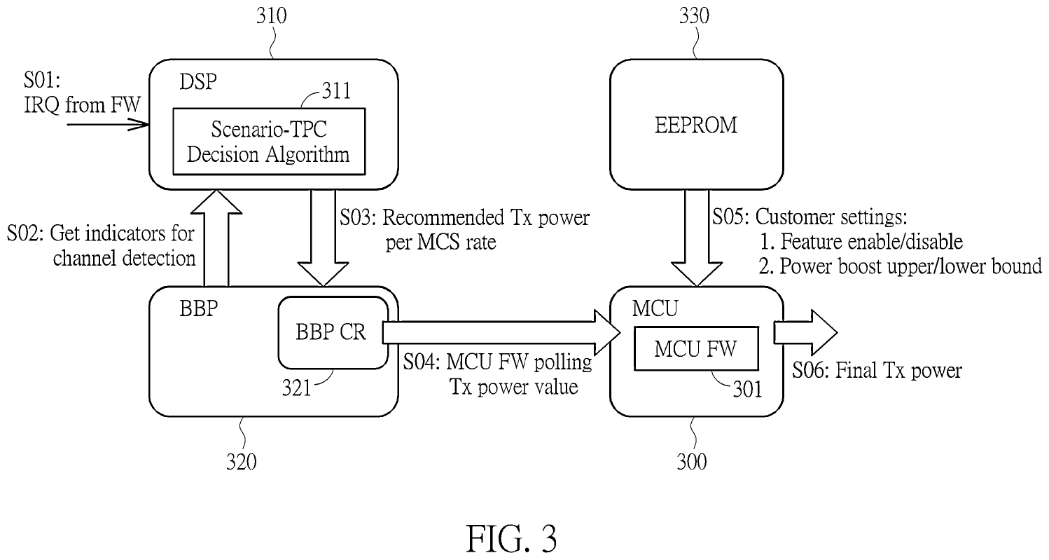

FIG. 3 illustrates a hybrid transmission power control scheme of the method according to an embodiment of the present invention. The aforementioned at least one communications control circuit such as the communications control circuit 114 may comprise at least one processor (e.g., one or more processors) such as a micro control unit (MCU) 300 (e.g., a microprocessor), a digital signal processor (DSP) 310 and a baseband processor (BBP) 320, and the aforementioned at least one program module may comprise a firmware (FW) module 301 running on the MCU 300 (labeled “MCU FW” for brevity) for controlling the operations of the communications control circuit 114, and further comprise a scenario-TPC program module 311 corresponding to a scenario-TPC decision algorithm of the method (labeled “Scenario-TPC Decision Algorithm” for brevity) for controlling the communications control circuit 114 to operate according to the scenario-based transmission power control scheme, where the storage device 116 may comprise the EEPROM 330, but the present invention is not limited thereto. According to some embodiments, the architecture of the wireless transceiver device 110 (or the components therein such as the communications control circuit 114 and the storage device 116) may vary, and the aforementioned at least one indicator may comprise one or a combination of at least one HW indicator, at least one FW indicator and at least one SW indicator. In addition, the communications control circuit 114 may be arranged to obtain the aforementioned at least one indicator from a first processor (e.g., the BBP 320) among the aforementioned at least one processor.

The communications control circuit 114 may operate according to the hybrid transmission power control scheme, and the associated operations may comprise:
(1) in Step S01, the DSP 310 may receive an interrupt IRQ from the FW module 301;
(2) in Step S02, the DSP 310 may get the indicators for channel detection from the BBP 320;
(3) in Step S03, the DSP 310 may send the recommended Tx_power per MCS rate to the BBP, and more particularly, send the recommended Tx_power per MCS rate to at least one control register (CR) 321 within the BBP 320 (labeled “BBP CR” for brevity);
(4) in Step S04, the FW module 301 may perform polling to obtain the aforementioned at least one transmission (Tx) power value Tx_power from the CR 321 of the BBP 320 (labeled “MCU FW polling Tx power value” for brevity);
(5) in Step S05, the FW module 301 may obtain one or more customer settings (e.g., feature enable/disable setting(s) and power boost upper/lower bound setting(s)) from the EEPROM 330;
(6) in Step S06, the FW module 301 may determine the final Tx power; but the present invention is not limited thereto. According to some embodiments, the associated operations of the hybrid transmission power control scheme may vary. For example, The communications control circuit 114 may detect the current channel based on one or more HW/SW indicators, and dynamically adjust the Tx power according to channel-model variation, rather than keeping the Tx power as fixed Tx power for all channel models (or all scenarios), for improving the RvR extension

As shown in FIG. 3, the aforementioned at least one processor may comprise multiple processors such as the DSP 310 and the BBP 320, but the present invention is not limited thereto. According to some embodiments, the aforementioned at least one processor may comprise a single processor, where the multiple processors may be integrated into the signal processor. For brevity, similar descriptions for these embodiments are not repeated in detail here.

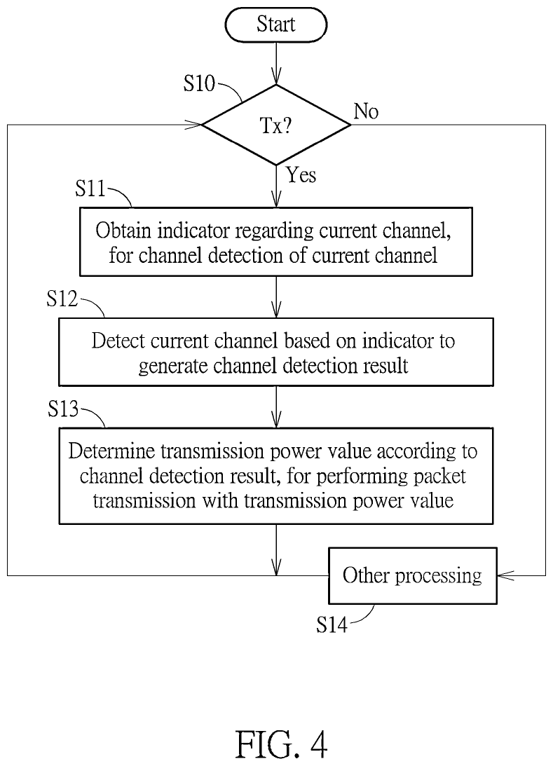

FIG. 4 illustrates a working flow of the method according to an embodiment of the present invention. For example, the aforementioned any wireless transceiver device #n such as the wireless transceiver device 110 (or the communications control circuit 114 therein) may operate according to the method as shown in FIG. 4, but the present invention is not limited thereto. For another example, another wireless transceiver device #n such as the wireless transceiver device 120 (or the communications control circuit 124 therein) may operate according to the method as shown in FIG. 4.

In Step S10, the communications control circuit 114 may check whether a current wireless communications operation is a transmission (Tx) operation (labeled “Tx” for brevity). If Yes, Step S11 is entered; if No, Step S14 is entered.

In Step S11, the communications control circuit 114 may obtain at least one indicator (e.g., the aforementioned at least one indicator) regarding the current channel, for channel detection of the current channel.

In Step S12, the communications control circuit 114 may detect the current channel based on the aforementioned at least one indicator (e.g., the indicator(s) that are just obtained in Step S11) to generate at least one channel detection result (e.g., the aforementioned at least one channel detection result), where when one of the aforementioned at least one channel detection result indicates a current channel model of the current channel, the current channel model may be one of the multiple predetermined channel models {Ch_Model(m)|m=1, 2, . . . } (e.g., the M predetermined channel models Ch_Model(1), Ch_Model(2), . . . and Ch_Model(M)).

In Step S13, the communications control circuit 114 may determine at least one transmission power value Tx_power (e.g., the aforementioned at least one transmission power value Tx_power) according to the aforementioned at least one channel detection result (e.g., the channel detection result(s) that are just generated in Step S12), for performing the packet transmission with the aforementioned at least one transmission power value Tx_power.

In Step S14, the communications control circuit 114 may perform other processing. For example, when the current wireless communications operation is a reception (Rx) operation, the communications control circuit 114 may perform Rx-related processing.

For example, the multiple predetermined channel models {Ch_Model(m)|m=1, 2, . . . } may comprise a first predetermined channel model Ch_Model(m1) and a second predetermined channel model Ch_Model(m2), where the first predetermined channel model Ch_Model(m1) and the second predetermined channel model Ch_Model(m2) may correspond to different EVM-demanding factors, and/or the first predetermined channel model Ch_Model(m1) and the second predetermined channel model Ch_Model(m2) may correspond to different delay spreads. In addition, the communications control circuit 114 may dynamically adjust the transmission power of the packet transmission per MCS rate according to the channel variation indicated by the aforementioned at least one channel detection result. For brevity, similar descriptions for this embodiment are not repeated in detail here.

For better comprehension, the method may be illustrated with the working flow shown in FIG. 4, but the present invention is not limited thereto. According to some embodiments, one or more steps may be added, deleted, or changed in the working flow shown in FIG. 4. For example, after determining the aforementioned at least one transmission power value Tx_power according to the aforementioned at least one channel detection result, for performing the packet transmission with the aforementioned at least one transmission power value Tx_power, the communications control circuit 114 may selectively perform the transmission power boost in at least one predetermined channel model Ch_Model(m) among the multiple predetermined channel models {Ch_Model(m)|m=1, 2, . . . } without performing the transmission power boost in another predetermined channel model Ch_Model(m) among the multiple predetermined channel models {Ch_Model(m)|m=1, 2, . . . }. For brevity, similar descriptions for these embodiments are not repeated in detail here.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing transmission power control of a wireless transceiver device in a wireless communications system, the method comprising:
obtaining at least one indicator regarding a current channel, for channel detection of the current channel;
detecting the current channel based on the at least one indicator to generate at least one channel detection result, wherein when one of the at least one channel detection result indicates a current channel model of the current channel, the current channel model is one of multiple predetermined channel models; and
determining at least one transmission power value according to the at least one channel detection result, for performing packet transmission with the at least one transmission power value.

2. The method of claim 1, further comprising:
after determining the at least one transmission power value according to the at least one channel detection result, for performing the packet transmission with the at least one transmission power value,
performing transmission power boost in at least one predetermined channel model among the multiple predetermined channel models without performing the transmission power boost in another predetermined channel model among the multiple predetermined channel models.

3. The method of claim 1, wherein detecting the current channel based on the at least one indicator to generate the at least one channel detection result further comprises:
detecting the current channel based on a first indicator among the at least one indicator to generate a first channel detection result among the at least one channel detection result, wherein the first channel detection result indicates that the current channel model of the current channel is a first predetermined channel model among the multiple predetermined channel models; and
detecting the current channel based on a second indicator among the at least one indicator to generate a second channel detection result among the at least one channel detection result, wherein the second channel detection result indicates that the current channel model of the current channel is a second predetermined channel model among the multiple predetermined channel models.

4. The method of claim 3, wherein determining the at least one transmission power value according to the at least one channel detection result for performing the packet transmission with the at least one transmission power value further comprises:
determining a first transmission power value among the at least one transmission power value according to the first channel detection result, for performing the packet transmission of at least one first packet with the first transmission power value; and
determining a second transmission power value among the at least one transmission power value according to the second channel detection result, for performing the packet transmission of at least one second packet with the second transmission power value.

5. The method of claim 1, wherein the multiple predetermined channel models comprise a first predetermined channel model and a second predetermined channel model, wherein the first predetermined channel model and the second predetermined channel model correspond to different error vector magnitude (EVM)-demanding factors.

6. The method of claim 1, wherein the multiple predetermined channel models comprise a first predetermined channel model and a second predetermined channel model, wherein the first predetermined channel model and the second predetermined channel model correspond to different delay spreads.

7. The method of claim 1, further comprising:
dynamically adjusting transmission power of the packet transmission according to channel variation indicated by the at least one channel detection result.

8. The method of claim 7, wherein dynamically adjusting the transmission power of the packet transmission according to the channel variation indicated by the at least one channel detection result further comprises:
dynamically adjusting the transmission power of the packet transmission per modulation and coding scheme (MCS) rate according to the channel variation indicated by the at least one channel detection result.

9. The method of claim 1, wherein determining the at least one transmission power value according to the at least one channel detection result for performing the packet transmission with the at least one transmission power value further comprises:
determining the at least one transmission power value per modulation and coding scheme (MCS) rate according to the at least one channel detection result, for performing the packet transmission with the at least one transmission power value.

10. The method of claim 1, wherein at least one communications control circuit within the wireless transceiver device comprises at least one processor; and obtaining the at least one indicator regarding the current channel for channel detection of the current channel further comprises:
obtaining the at least one indicator from a first processor among the at least one processor.

11. The method of claim 10, wherein the first processor is a baseband processor.

12. The method of claim 1, wherein the at least one indicator comprises one or a combination of at least one hardware indicator, at least one firmware indicator and at least one software indicator.

13. A wireless transceiver device, for performing transmission power control of the wireless transceiver device in a wireless communications system, the wireless transceiver device being one of multiple devices within the wireless communications system, the wireless transceiver device comprising:
a processing circuit, arranged to control operations of the wireless transceiver device; and
at least one communications control circuit, coupled to the processing circuit, arranged to perform communications control, wherein the at least one communications control circuit is arranged to perform wireless communications operations with another device among the multiple devices within the wireless communications system for the wireless transceiver device;
wherein:
the at least one communications control circuit is arranged to obtain at least one indicator regarding a current channel, for channel detection of the current channel;
the at least one communications control circuit is arranged to detect the current channel based on the at least one indicator to generate at least one channel detection result, wherein when one of the at least one channel detection result indicates a current channel model of the current channel, the current channel model is one of multiple predetermined channel models; and
the at least one communications control circuit is arranged to determine at least one transmission power value according to the at least one channel detection result, for performing packet transmission with the at least one transmission power value.

14. The wireless transceiver device of claim 13, wherein after determining the at least one transmission power value according to the at least one channel detection result, for performing the packet transmission with the at least one transmission power value, the at least one communications control circuit is arranged to perform transmission power boost in at least one predetermined channel model among the multiple predetermined channel models without performing the transmission power boost in another predetermined channel model among the multiple predetermined channel models.

15. The wireless transceiver device of claim 13, wherein the at least one communications control circuit comprises at least one processor; and the at least one communications control circuit is arranged to obtain the at least one indicator from a first processor among the at least one processor.

16. The wireless transceiver device of claim 15, wherein the first processor is a baseband processor.
